(19) United States
(12) Patent Application Publication
(10) Pub. No.: US 2014/0117628 A1
(43) Pub. Date: May 1, 2014

(54) SEALING MEMBER OF DISK TYPE PARKING BRAKE

(71) Applicants: HYUNDAI MOTOR COMPANY, Seoul (KR); KIA MOTORS CORPORATION, Seoul (KR)

(72) Inventor: Jae Ho Jang, Daegu (KR)

(73) Assignees: Kia Motors Corporation, Seoul (KR); Hyundai Motor Company, Seoul (KR)

(21) Appl. No.: 13/705,061

(22) Filed: Dec. 4, 2012

(30) Foreign Application Priority Data
Oct. 26, 2012 (KR) 10-2012-0119949

(51) Int. Cl. B60T 17/00

(52) U.S. Cl. CPC B60T 17/00
USPC 277/589

(57) ABSTRACT

A sealing member for sealing a disk type parking brake may include a cap member having a hole in the center and pressed in a rear end portion of the caliper at which the shaft may be mounted, and an elastic member which may be mounted between the cap member and the rear end portion of the caliper and extended to the outside of the caliper for sealing the shaft and the brake lever, wherein the elastic member includes a slope portion which may be positioned between the cap member and the rear end portion of the caliper and may be slantly protruding out in radial direction, and one end portion of the cap member may be contacted with the outer surface of the slope portion by being bended out in radial direction.

### CROSS-REFERENCE TO RELATED APPLICATION

The present application claims priority to Korean Patent Application No. 10-2012-0119949 filed on Oct. 26, 2012, the entire contents of which is incorporated herein for all purposes by this reference.

### BACKGROUND OF THE INVENTION

1. Field of the Invention

The present invention relates to a sealing member of a disk type parking brake for improving air-tightness performance of the disk type parking brake.

2. Description of Related Art

In general, a brake mounted at a vehicle for reducing vehicle speed or stopping the vehicle may be classified as a drum brake and a disk brake. And the parking brake for maintaining the vehicle to stop when the vehicle is parked. The parking brake is connected with parking cable provided for operating the parking brake. And the parking cable is operated by connecting with a parking lever controlled by a vehicle driver or a cable controller driven by an electrical device

Above all, the disk type parking brake gets a braking force by making friction by pressing and attaching a disk pads to each side of disk which is rotation with a wheel of vehicle.

The disk type parking brake generally includes a disk rotation with wheel of vehicle, an inner and outer disk pads which are mounted at inner and outer of the disk respectively, a caliper for operating the inner and outer disk pads, a piston installed at the caliper, a carrier for supporting the caliper movably, and an actuator for operating the piston.

The caliper is slidably installed at the carrier to locate at a side of external circumference of the disk. And the carrier is fixed at a knuckle of the vehicle. The caliper has a cylinder in which the piston is movably accommodated. The piston presses the disk pad for attaching the disk pad onto the disk by moving forward in the cylinder.

The actuator is connected with the parking cable, and pressurizes the piston toward the disk when the parking cable works.

The actuator may be a cam-strut type actuator which uses a cam rotating by parking cable and a strut installed between the cam and the piston, or may be a ball in ramp type actuator which includes a fixed ramp plate mounted at the inside of the caliper, a rotating ramp plate rotating by parking cable which is connected to a lever member, a ball installed between the fixed ramp plate and the rotating ramp plate, and a pushrod which is in contiguity with the rotating ramp plate and pushes the piston.

In the case of the ball in ramp type actuator, a shaft part extending to the outside of the caliper is connected with the rotating ramp plate, and the lever member is communicated with the shaft part. Further, a sealing member is mounted at the circumference of the shaft part for sealing a gap between the caliper and lever member. An end portion of the sealing member is fixed at the caliper.

However, the sealing member is twisted by a friction of the lever member and the shaft part as a result the contact with the shaft part may be separated. Therefore the air-tightness performance of the sealing member is deteriorated and water and foreign substances penetrate into the caliper and the shaft part. As a result, the prior parking brake has a problem of deteriorating braking performance because the penetration of the water and the foreign substances can produce rust.

The prior art changes the structure of the caliper for solving the above mentioned problems. However, the expense of changing structure of the caliper is high since the mold of the caliper also should be changed to change the structure of the caliper, and the structure of the caliper becomes more complicated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sealing member of disk type parking brake having advantages of improving air-tightness performance of caliper of disk type parking brake without changing structure of caliper.

In an aspect of the present invention, a sealing member for sealing a disk type parking brake which may include a shaft rotating with a brake lever, an actuator converting a rotational movement of the shaft into a reciprocal movement by contacting with the shaft, a piston pressurized by the actuator to form the reciprocal movement, a friction member producing braking force pressurized by the piston and contacted with a disk, and a caliper where the shaft, the actuator, the piston, and the friction member are installed, may include a cap member having a hole in the center thereof and pressed in a rear end portion of the caliper at which the shaft is mounted, and an elastic member which is mounted between the cap member and the rear end portion of the caliper and extended to the outside of the caliper for sealing the shaft and the brake lever, wherein the elastic member may include a slope portion which is positioned between the cap member and the rear end portion of the caliper and is slantly protruding out in a radial direction thereof, and wherein one end portion of the cap member is contacted with an outer surface of the slope portion by being bended out in radial direction thereof.

The rear end portion of the caliper may include a protruding portion which is cylindrically protruding so that the shaft passes through therein.

The elastic member may include a caliper seal portion sealing a gap between the cap member and the protruding portion, a shaft seal portion extending from the caliper seal portion and sealing an exterior circumference of the shaft, and a lever seal portion extending from the shaft seal portion and sealing an exterior circumference of the brake lever, wherein the slope portion is formed at an end of the caliper seal portion, and the radius of the slope portion becomes larger toward the end of the caliper seal portion.

The sealing member may include a guide bracket mounted at an exterior diameter of the cap member.

The caliper seal portion may include a protruding lip protruding to contact with a rear surface of the protruding portion, and at least one caliper lip that is protruding inwardly in a radial direction of the caliper seal portion to contact with an exterior circumference of the protruding portion.

The shaft seal portion may include at least one shaft lip that is protruding inwardly in a radial direction thereof to contact with an exterior circumference of the shaft.

The lever seal portion may include at least one lever lip that is protruding to contact with the exterior circumference of the brake lever, and at least one supporting lip which is slantly protruding outwardly in the radial direction toward the exterior circumference of the brake lever.

The other end portion of the cap member is bending toward the brake lever, wherein the elastic member may include a fixing portion having a groove in which the other end portion of the cap member is pressed.

The cap member is made of steel use stainless (SUS) material.

The elastic member is made of a rubber material.

Due to the sealing member of disk type parking brake according to the exemplary embodiment of the present invention, the caliper of disk type parking brake can be sealed more completely without changing the structure of the caliper.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of the disk type parking brake according to an exemplary embodiment of the present invention.

FIG. 2 is a perspective view of the sealing member of the disk type parking brake according to an exemplary embodiment of the present invention.

FIG. 3 is a cross-sectional view of the sealing member of the disk type parking brake according to an exemplary embodiment of the present invention.

FIG. 4 is a cross-sectional view of an elastic member according to an exemplary embodiment of the present invention.

FIG. 5 is a cross-sectional view of cap member according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to accompanying drawings.

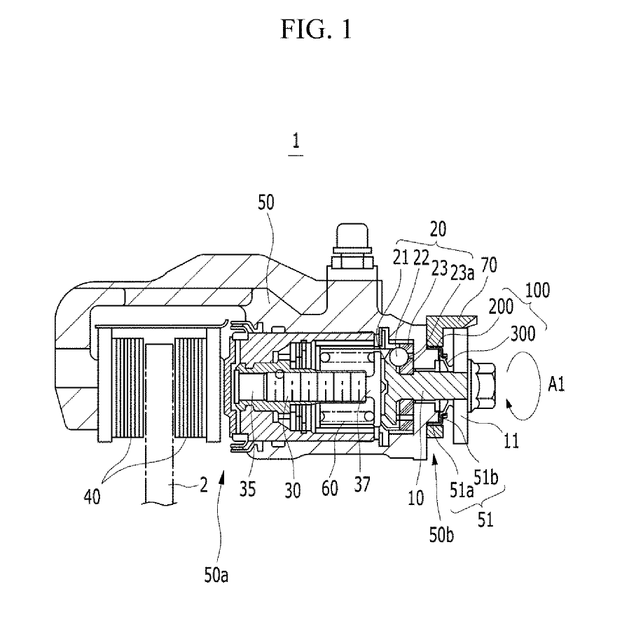

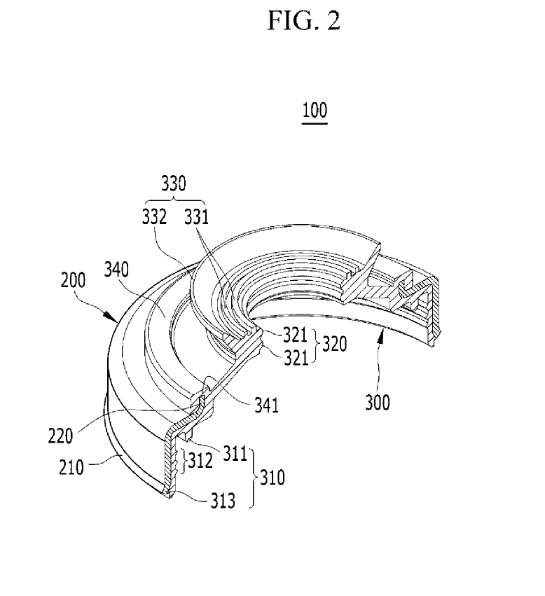

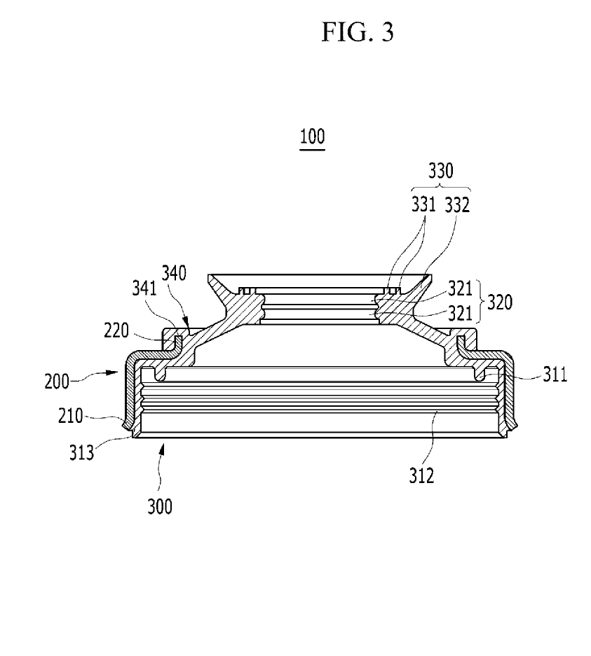

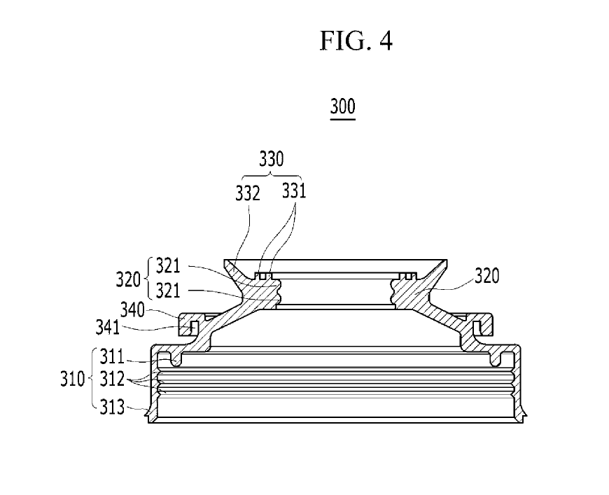

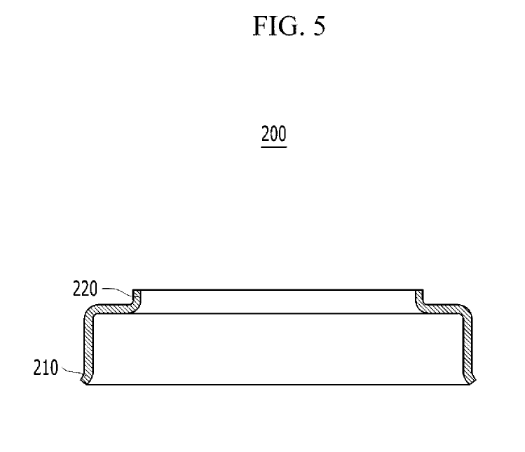

FIG. 1 is a cross-sectional view of the disk type parking brake 1 according to an exemplary embodiment of the present invention, FIG. 2 is a perspective view of the sealing member 100 of the disk type parking brake according to an exemplary embodiment of the present invention, FIG. 3 is a cross-sectional view of the sealing member 100 of the disk type parking brake according to an exemplary embodiment of the present invention, FIG. 4 is a cross-sectional view of an elastic member 300 according to an exemplary embodiment of the present invention, and FIG. 5 is a cross-sectional view of cap member 200 according to an exemplary embodiment of the present invention.

As referring FIG. 1 to FIG. 5, the sealing member of a parking brake according an exemplary embodiment of the present invention is applied to a disk type parking brake.

The disk type parking brake may include a disk 2, a brake lever 11, a shaft 10, an actuator 20, a cylinder 35, a piston 30, a pushrod 37, a friction member 40, a caliper 50, a spring 60, a guide bracket 70, and the sealing member 100.

The disk 2 rotates with wheel of a vehicle.

The friction member 40 makes a braking force by contacting with the disk 2. And the friction member may be a pair of pad plates 40 mounted at both sides of the disk 2

The brake lever 11 is connected with a parking cable, and is rotatably mounted at the rear portion 50b of the caliper 50. On the basis of the FIG. 1, a front portion 50a of the caliper may refer to a forepart where the disk 2 is mounted, and the rear portion 50b of the caliper may refer to a back end where the shaft is mounted. The brake lever 11 rotates when the parking brake is operated by a driver of the vehicle.

The shaft 10 is axially engaged with the brake lever 50 and is extended inside of the caliper 50 through the rear portion 50b of the caliper 50. The shaft 10 rotates with the brake lever 11. In some exemplary embodiments, a spline is formed at one end of the shaft 10, and a groove corresponding with the spline is formed at the brake lever 11 so that the one end of the shaft 10 and the brake lever 100 may be engaged with spline.

The caliper 50 is provided for operating the friction member 40. And the caliper 50 may be slidably installed at a carrier which is fixed at a knuckle of the vehicle. The actuator 20, cylinder 35, piston 30, pushrod 37, and spring 60 and others may be mounted inside the caliper 50.

In some exemplary embodiments, as shown in FIG. 1, the rear portion 50b of the caliper 50 may includes a protruding portion 51 which is cylindrically protruding to mount the shaft 10, the guide bracket 70, and the sealing member 100 and others.

The actuator 20 delivers a force to the front by converting the rotational movement of the shaft 10 into reciprocal movement. The actuator may be a cam-strut type actuator which uses a cam rotating by parking cable and a strut installed between the cam and the piston, or may be a ball in ramp type actuator in which the shaft moves to the front with rotating along to a sloping groove guiding by a ball.

FIG. 1 represents the ball in ramp type actuator as an exemplary embodiment. As shown in FIG. 1, the actuator 20 may include a fixed ramp plate 23 which is mounted at the inside of the caliper 50, a rotating ramp plate 21 which rotating with the shaft, a ball 22 which is installed between the fixed ramp plate 23 and the rotating ramp plate 21 and is guided by the sloping groove 23a, and a pushrod 37 which pushes the piston 30 by being mounted between the rotating ramp plate 21 and the piston 30.

The rotating ramp plate 21 may be engaged at the other side of the shaft 10 or may be integrally formed with the other side of the shaft 10

If the brake lever 11 and the shaft 10 by the operation of the parking brake, then the rotating ramp plate 21 also rotates. The rotating ramp plate 21 moves to the front with rotating because the rotating ramp plate 21 rotates with contacting at the ball 22 which is guided by the sloping groove 23a. Therefore, the rotational movement of the shaft 10 is converted to the reciprocal movement.

However, the scope of the present invention is not limited to the above mentioned ball in ramp type actuator, not only the cam-strut type actuator and ball in ramp type actuator but any other types of actuator can be applied to the present invention.

The cylinder 35 in which the piston 30 is movably accommodated is mounted at the inside of the caliper 50.

The piston 30 moves to the front in the cylinder 35 because the piston 30 is pressurized by the pushrod 37. As a result the piston 30 pressures the friction member 40 and the friction member 40 is contacted to the disk 2 and it generates braking force.

The spring 60 provides a restoring force to the pushrod 37 for separating the friction member 40 from the disk 2 when the brake is released

The guide bracket 70 is mounted at the rear portion 50b of the caliper 50. The guide bracket 70 supports the parking cable which is connected to the brake lever 11, and guides the motion of the parking cable.

The sealing member 100 prevents water and foreign substances from penetrating through the interior of the caliper 50 by mounting at the rear portion 50b of the caliper 50 and sealing the brake lever 11, the caliper 50, and a part of the shaft 10 which is positioned between the brake lever 11 and the caliper 50.

In some exemplary embodiments, the sealing member 100 may include a cap member 200 having a hole in the center and pressed in the protruding portion 51 of the caliper 50, and an elastic member 300 which is mounted between the cap member 200 and the protruding portion 51 and extended to the shaft 10 and the brake lever 11.

In some exemplary embodiments, the cap member 200 may be made of steel use stainless SUS material and the elastic member 300 may be made of a rubber material.

In some exemplary embodiments, as shown in FIG. 1 to FIG. 4, the elastic member may include a caliper seal portion 310 sealing a gap between the cap member 200 and the protruding portion 51, a shaft seal portion 320 extending from the caliper seal portion 310 and sealing an exterior circumference of the shaft 10, a lever seal portion 330 extending from the shaft seal portion 320 and sealing an exterior circumference of the brake lever 11, and a fixing portion 340 engaging with the cap member 200.

In some exemplary embodiments, the caliper seal portion 310 may include a slope portion 313 which is slantly protruding out in radial direction at the end of the caliper seal portion 310. As shown in FIG. 3 and FIG. 4, the slope portion 313 may be formed such that the radius of the slope portion 313 becomes larger toward the end of the caliper seal portion 310.

Meanwhile, one end portion 210 of the cap member 200 may be bended out in radial direction to contact with the outer surface of the slope portion 313 of the caliper seal portion 310 as shown if FIG. 3. And the other end portion 220 of the cap member 200 may be bended toward the brake lever 11 so as to be pressed in the groove 340 which is formed at the fixing portion 340 of the elastic member 300.

The brake lever 11 pressurizes the sealing member 100 in the direction of the caliper 50 when it is installed. The force that the brake lever 11 pressurizes the sealing member 100 is transmitted to the slope portion 313 through the one end portion 210 of the cap member 200. At this moment, the direction of the pressurizing force is divided into two directions such that a direction toward the caliper 50 and a direction toward the protruding portion 51 by the slope portion 313. As a result, the sealing performance can be improved because the end of the caliper seal portion 310 pressures the protruding portion 51 inwardly in radial direction.

Particularly, as shown in FIG. 1, the force which is transmitted to the slope portion 313 and the caliper seal portion 310 does not dispersed out in radial direction when the guide bracket 70 is mounted at the exterior diameter of the cap member 200 by tightly contacting with the exterior diameter of the cap member 200. Therefore, the caliper seal portion 310 of the elastic member 300 can seal the protruding portion 51 more completely.

In some exemplary embodiments, the caliper seal portion 310 of the caliper seal portion 300 may include a protruding lip 311 protruding to contact with the rear surface 51b of the protruding portion 51, and three caliper lips 312 that are protruding inwardly in the radial direction to contact with the exterior diameter surface 51 a of the protruding portion 51 as shown in FIG. 1 to FIG. 4. Foreign substances and water can be blocked more completely because not only the slope portion 313 but the protruding lip 311 and three caliper lips 312 are sealing the protruding portion 51.

In some exemplary embodiments, the shaft seal portion 320 of the elastic member 300 may include two shaft lips 321 that are protruding inwardly in the radial direction to contact with the exterior diameter surface of the shaft 10 as shown in FIG. 1 to FIG. 4.

In some exemplary embodiments, the lever seal portion 330 of the elastic member 300 may include two lever lips 331 that are protruding to contact with the exterior circumference of the brake lever 11, and at least one supporting lip 332 which is slantly protruding outwardly in the radial direction toward the exterior circumference of the brake lever 11 as shown if FIG. 1 to FIG. 4.

Therefore, the caliper 50 of disk type parking brake can be sealed more completely without changing the structure of the rear portion 50b of the caliper 50 due to the sealing member 100 of disk type parking brake according to the exemplary embodiment of the present invention.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sealing member for sealing a disk type parking brake which includes a shaft rotating with a brake lever, an actuator converting a rotational movement of the shaft into a reciprocal movement by contacting with the shaft, a piston pressurized by the actuator to form the reciprocal movement, a friction member producing braking force pressurized by the piston and contacted with a disk, and a caliper where the shaft, the actuator, the piston, and the friction member are installed, comprising:
a cap member having a hole in the center thereof and pressed in a rear end portion of the caliper at which the shaft is mounted; and
an elastic member which is mounted between the cap member and the rear end portion of the caliper and extended to the outside of the caliper for sealing the shaft and the brake lever,
wherein the elastic member includes a slope portion which is positioned between the cap member and the rear end portion of the caliper and is slantly protruding out in a radial direction thereof, and
wherein one end portion of the cap member is contacted with an outer surface of the slope portion by being bended out in radial direction thereof.

2. The sealing member of claim 1, wherein the rear end portion of the caliper includes a protruding portion which is cylindrically protruding so that the shaft passes through therein.

3. The sealing member of claim 2, wherein the elastic member includes:
a caliper seal portion sealing a gap between the cap member and the protruding portion;
a shaft seal portion extending from the caliper seal portion and sealing an exterior circumference of the shaft; and
a lever seal portion extending from the shaft seal portion and sealing an exterior circumference of the brake lever,
wherein the slope portion is formed at an end of the caliper seal portion, and the radius of the slope portion becomes larger toward the end of the caliper seal portion.

4. The sealing member of claim 2, further including a guide bracket mounted at an exterior diameter of the cap member.

5. The sealing member of claim 3, wherein the caliper seal portion includes:
a protruding lip protruding to contact with a rear surface of the protruding portion; and
at least one caliper lip that is protruding inwardly in a radial direction of the caliper seal portion to contact with an exterior circumference of the protruding portion.

6. The sealing member of claim 3, wherein the shaft seal portion includes at least one shaft lip that is protruding inwardly in a radial direction thereof to contact with an exterior circumference of the shaft.

7. The sealing member of claim 3, wherein the lever seal portion includes:
at least one lever lip that is protruding to contact with the exterior circumference of the brake lever; and
at least one supporting lip which is slantly protruding outwardly in the radial direction toward the exterior circumference of the brake lever.

8. The sealing member of claim 2,
wherein the other end portion of the cap member is bending toward the brake lever, and
wherein the elastic member includes a fixing portion having a groove in which the other end portion of the cap member is pressed.

9. The sealing member of claim 1, wherein the cap member is made of steel use stainless (SUS) material.

10. The sealing member of claim 1, wherein the elastic member is made of a rubber material.
